(19) United States
(12) Patent Application Publication
(10) Pub. No.: US 2017/0003911 A1
(43) Pub. Date: Jan. 5, 2017

(54) INFORMATION PROCESSING DEVICE

(71) Applicant: HITACHI, LTD., Chiyoda-ku, Tokyo (JP)

(72) Inventors: Hiroshi UCHIGAITO, Tokyo (JP); Seiji MIURA, Tokyo (JP); Kenzo KUROTSUCHI, Tokyo (JP)

(21) Appl. No.: 15/113,747

(22) PCT Filed: Feb. 3, 2014
(86) PCT No.: PCT/JP2014/052440

§ 371 Date: Jul. 22, 2016

(51) Int. Cl. G06F 3/06

(52) U.S. Cl. CPC G06F 3/0652; G06F 3/061; G06F 3/0616; G06F 3/0638; G06F 3/0647; G06F 3/0688

(57) ABSTRACT

An information processing apparatus including a memory subsystem connected to a host to perform arithmetic processing, where the host notifies a write request including data and a type of the data to the memory subsystem, and, based on a first memory, a second memory which has a size of a data erase unit, for erasing data, larger than a size of a write unit of the data and a data capacity larger than that of the first memory, and the type of the data, the memory subsystem writes random access data and data other than the random access data in different erase units of the second memory.

### TECHNICAL FIELD

The present invention relates to an information processing device and a computer suitable for high-speed processing of a large amount of data such as big data.

### BACKGROUND ART

Demands for predicting or managing various phenomena in the society by analyzing a large amount of data such as big data by computers will grow in the future. This results in an explosive increase of data volume handled by a computer and thus it is desirable to use a large capacity nonvolatile memory capable of storing big data at a low cost with low power consumption. Furthermore, a computer needs to read and write a large amount of data in analysis of big data and therefore raising the speed of reading and writing is also desired.

In storage devices using conventional nonvolatile memories, a data erase unit (block) is larger than a data write unit and thus even unnecessary data cannot be overwritten. Therefore, when a block is filled with necessary data and unnecessary data, new data cannot be written in the block as it is.

Therefore, when a writable area for random access is in shortage when a host (processor) writes new data to the storage device, a controller of the storage device first reads, from each block, necessary data physically scattered and then erases the block where the data has been read. Next, the controller of the storage device writes the read data in the erased block. It has been general to ensure a new writable area in this manner. This processing is called garbage collection.

Moreover, PTL 1 discloses a technique where a storage device using a nonvolatile memory manages data by classification based on values of logical addresses of data and stores, in the same block, data having close values of logical addresses.

### CITATION LIST

### Patent Literature

PTL 1: JP 2009-64251 A

### SUMMARY OF INVENTION

### Technical Problem

Occurrence of garbage collection in a storage device using a nonvolatile memory leads to performance degradation of a storage device due to waiting of read and write processing in a host during processing of garbage collection and further leads to a reduced lifetime of the storage device having an upper limit for an erase cycle since garbage collection itself includes erase processing.

Also in the above big data analysis, the host to execute data analysis issues, to the storage device using the nonvolatile memory, a request to sequentially read/write/erase data by large data sizes and a random access request in a mixture. Therefore, random access data and other data exist in the same block of the nonvolatile memory in a mixture. As a result, data other than random access data which originally does not need to be moved or erased in garbage collection is also moved or erased and thus performance degradation or a reduced lifetime due to garbage collection is substantial.

In the technique disclosed in the aforementioned PTL 1, data is classified and managed only by values of logical addresses and thus random access data and other data still exist in the same block of the nonvolatile memory in a mixture. Therefore, data other than random access data which originally does not need to be moved or erased in garbage collection is also moved or erased and thus the above problem is not solved.

Therefore, an object of the present invention is to enhance efficiency of garbage collection in a nonvolatile memory of a low cost with a large capacity, to thereby raise the speed of reading and writing of data in a storage device using the nonvolatile memory, and to extend a lifetime of the storage device.

### Solution to Problem

The present invention is an information processing apparatus including a host to perform arithmetic processing and a memory subsystem connected to the host, where the host notifies a write request including data and a type of the data to the memory subsystem, and the memory subsystem includes a first memory, a second memory which has a size of a data erase unit, for erasing data, larger than a size of a write unit of the data and a data capacity larger than that of the first memory, and a memory subsystem control module to write random access data and data other than the random access data in different erase units of the second memory based on the type of the data, to manage the random access data by the write unit of the second memory, and to manage the data other than the random access data by the erase unit of the second memory.

### Advantageous Effects of Invention

The present invention allows for providing a large-scale memory space required for analysis or the like of a large amount of data, such as big data, by a nonvolatile memory at a low cost. Even when a request to sequentially read, write, or erase data by large data sizes and a random access request from a host to a storage device using a nonvolatile memory occur in a mixture, the random access and the other access are stored in different erase units of the nonvolatile memory. This allows for enhancing efficiency of garbage collection in the nonvolatile memory. This also allows for implementing read and write of data at a high speed and extending a lifetime of the storage device using the nonvolatile memory.

### BRIEF DESCRIPTION OF DRAWINGS

FIG. 1 is a block diagram illustrating an example 1 of the present invention and an exemplary server.

FIG. 2 is a block diagram illustrating the example 1 of the present invention and an exemplary memory subsystem.

FIG. 3 is a block diagram illustrating the example 1 of the present invention and an example of a configuration of a chip, a block, and a page of a nonvolatile memory in the memory subsystem and a processing object of read, write, and erase processing.

FIG. 4 is a diagram illustrating the example 1 of the present invention and an exemplary graph configuring big data to be processed by a server.

FIG. 5 is a diagram illustrating the example 1 of the present invention and an exemplary sequence of graph analysis processing executed in the server.

FIG. 6 is a diagram illustrating the example 1 of the present invention and exemplary information sent from a host to a memory subsystem.

FIG. 7 is a block diagram illustrating the example 1 of the present invention and exemplary correspondence relation among a chip, a block, and a page of the nonvolatile memory, a data group, and random access data.

FIG. 8 is a block diagram illustrating the example 1 of the present invention and other exemplary correspondence relation among a chip, a block, and a page of the nonvolatile memory, a data group, and random access data.

FIG. 9A is a diagram illustrating the example 1 of the present invention and an exemplary logical/physical conversion table.

FIG. 9B is a diagram illustrating the example 1 of the present invention and an exemplary block management table.

FIG. 9C is a diagram illustrating the example 1 of the present invention and an exemplary attribute physical conversion table.

FIG. 10 is a flowchart illustrating the example 1 of the present invention and exemplary data write processing.

FIG. 11 is a block diagram illustrating an example 2 of the present invention and exemplary correspondence relation among a chip, a block, and a page of a nonvolatile memory and a group of compressed data.

FIG. 12A is a diagram illustrating the example 2 of the present invention and an exemplary change of a data size before and after data compression processing.

FIG. 12B is a diagram illustrating the example 2 of the present invention and an exemplary change of a data size before and after data compression processing.

FIG. 13A is a diagram illustrating the example 2 of the present invention and an exemplary logical/physical conversion table upon compressing data.

FIG. 13B is a diagram illustrating the example 2 of the present invention and an exemplary DRAM buffer management table.

FIG. 14A is a flowchart illustrating the second example of the present invention and exemplary data compression and write processing preformed in a memory subsystem.

FIG. 14B is a flowchart illustrating the example 2 of the present invention and exemplary data compression and write processing preformed in the memory subsystem.

FIG. 15 is a block diagram illustrating an example 3 of the present invention and exemplary correspondence relation among a chip and a block of a nonvolatile memory and a stored data type.

FIG. 16 is a block diagram illustrating the example 3 of the present invention and exemplary correspondence relation among the chip and the stored data type when different types of chips of the nonvolatile memory are mixed.

FIG. 17 is a flowchart illustrating the example 3 of the present invention and exemplary processing of writing destination selection.

FIG. 18 is a diagram illustrating the example 3 of the present invention and an exemplary last writing block management table of the nonvolatile memory.

### DESCRIPTION OF EMBODIMENTS

Hereinafter, embodiments of the present invention will be described with reference to the accompanying drawings.

### Example 1

### A. Configuration of Server

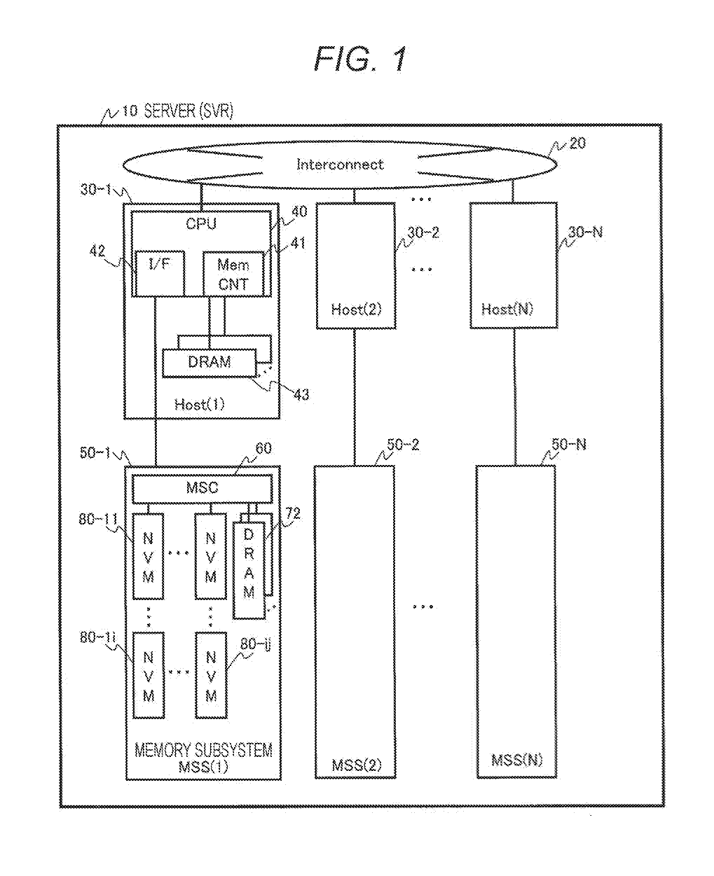

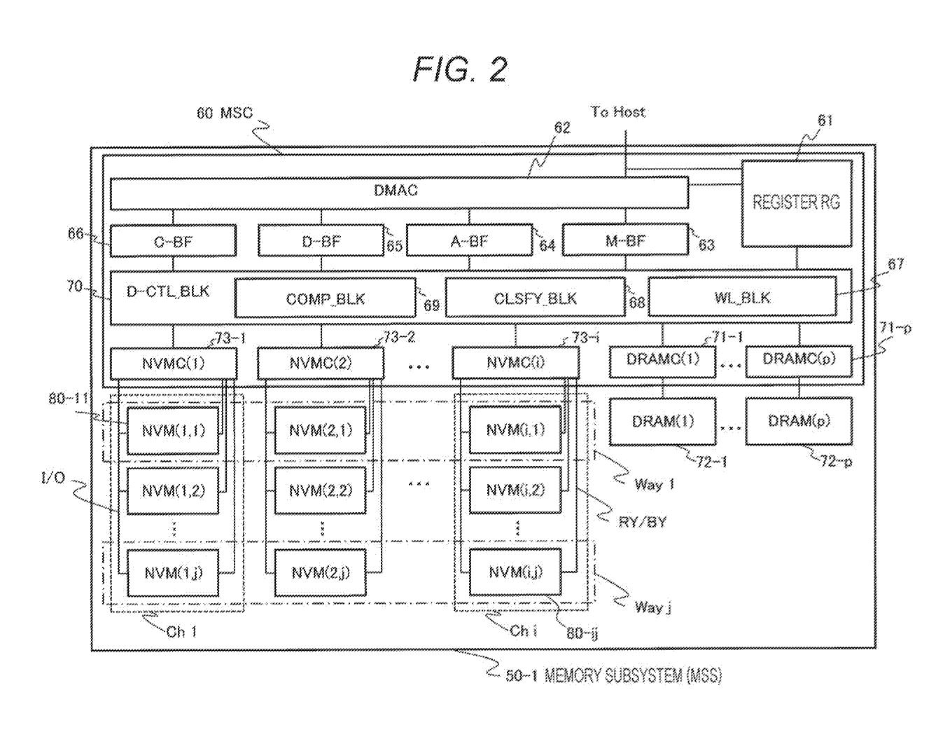

First, a configuration of a server (SVR) 10 will be described with FIGS. 1 and 2. FIG. 1 is a block diagram illustrating an overall configuration of the server (information processing apparatus) 10 to perform information processing.

The server (SVR) 10 includes a plurality of hosts (Host (1) 30-1 to Host (N) 30-N) to perform arithmetic processing, interconnect 20 connecting all of the hosts 30-1 to 30-N with each other, and a plurality of memory subsystems (MSS (1) to MSS (N)) 50-1 to 50-N connected to hosts 30-1 to 30-N thereof. Incidentally, the hosts 30-1 to 30-N are collectively denoted with a symbol 30 in the descriptions below. This similarly applies to other elements with a symbol without “-” collectively representing elements and a symbol added with “-” representing an individual element.

The host 30 includes an arithmetic module (CPU) 40 to perform arithmetic processing and one or more memories (DRAM) 43 connected to a memory controller 41 of the arithmetic module 40. The arithmetic module 40 executes a program stored in the memory 43 and executes processing by reading information from the memory 43 and writing information to the memory 43.

All of the hosts 30 can communicate with each other via the interconnect 20. Furthermore, the host 30 can mutually communicate with the memory subsystem 50 individually connected thereto via an interface 42 of the arithmetic module 40. FIG. 1 illustrates the example where the interface 42 is included in the arithmetic module 40; however, the present invention is not limited to this example as long as the host 30 can perform data communication with the memory subsystem 50. As the interface 42, for example PCI Express, DIMM, or the like can be employed.

As illustrated in FIG. 2, each of the memory subsystem 50-1 includes one memory subsystem control module (MSC) 60, one or more nonvolatile memories (NVM) 80-11 to 80ij, and one or more memories (DRAM) 72-1 to 72-p. The memory subsystem control module 60 can mutually communicate with the host 30-1, the nonvolatile memory 80, and the memory 72. Incidentally, the memory subsystems 50-2 to 50-N have similar configurations as that of the memory subsystem 50-1 and thus overlapping descriptions are omitted. Incidentally, in the example illustrated, each of the nonvolatile memories 80-11 to 80ij is configured by one chip. Incidentally, data stored in the DRAM 72 can be saved in backup in the nonvolatile memory 80 or the like upon interruption of power by a battery backup although not illustrated.

The memory 72 in the memory subsystem 50 stores management information or the like and is preferably a high-speed DRAM but may also be an MRAM, phase-change memory, SRAM, NOR flash memory, ReRAM, or the like other than a DRAM. Moreover, data to write to the nonvolatile memory 80 and data to read may be temporarily stored and used as cache of the nonvolatile memory 80. The nonvolatile memory 80 stores data written by the host 30 and has a size of a data erase unit larger than or equal to a size of a data write unit, such as a NAND flash memory, phase-change memory, or ReRAM having a large capacity at a low cost.

FIG. 2 is a block diagram illustrating the memory subsystem 50 further in detail.

The memory subsystem 50 includes one memory subsystem control module (MSC) 60, nonvolatile memories (NVM (1, 1) to NVM (i, j)) 80-11 to 80ij, and memories (DRAM (1) to DRAM (p)) 72-1 to 72-p (where i, j, and p represent natural numbers).

The memory subsystem control module 60 includes a memory access controller (DMAC) 62, a command buffer (C-BF) 66, a data buffer (DBF) 65, an address buffer (A-BF) 64, a metadata buffer (M-BF) 63, a register (RG) 61, a data control block (D-CTL_BLK) 70, nonvolatile memory controllers (NVMC (1) to NVMC (i)) 73-1 to 73-i, and DRAM controllers (DRAMC (1) to DRAMC (p)) 71-1 to 71-p.

The data control block 70 includes a data compression block (COMP_BLK) 69, a data classification block (CLSFY_BLK) 68, and a wear-leveling block (WL_BLK) 67.

The memory access controller (DMAC) 62 is connected to the host 30 in FIG. 1, the command buffer 66, the data buffer 65, the address buffer 64, the metadata buffer 63, and the register 61 and relays communication with the connecting destination (host 30).

Each of the command buffer 66, the data buffer 65, the address buffer 64, the metadata buffer 63, and the register 61 is also connected to the data control block 70. The command buffer 66 temporarily stores a data read command, write command, erase command, or the like. The data buffer 65 temporarily stores data to read or write. The address buffer 64 temporarily stores an address of data of a read, write, or erase command from the host 30. Incidentally, the address buffer 64 can also temporarily store a size of data.

The metadata buffer 63 temporarily stores metadata such as a group number of data of a read, write, or erase command from the host 30, whether data is random access data or not, and a type of data (graph data (CSR), analysis result (MSG), vertex information (VAL)). Note that the metadata is not limited thereto but may be information other than the above.

The register 61 stores control information required for each control in the data control block 70 and allows for reading from the data control block 70.

The data control block 70 communicates with the register 61, the command buffer 66, the data buffer 65, the address buffer 64, and the metadata buffer 63 and controls the nonvolatile memory controller 73 and the DRAM controller 71.

The nonvolatile memory controllers (NVMC (1) to NVMC (i)) 73-1 to 73-i are connected to the nonvolatile memories (NVM (i, 1) to NVM (i, j)) 80-11 to 80-ij and perform reading data, writing data, and erasing data of the nonvolatile memory 80 connected thereto. Here, i is a natural number representing a channel number where a plurality of channels includes data transfer bus (I/O) each capable of independent communication. The j nonvolatile memories (NVM(i, 1), NVM(i, 2), . . . , NVM(i, j)) 80 belonging to one channel share the data transfer bus (I/O).

Moreover, j nonvolatile memories 80 belonging to the respective channels (Ch 1 to Ch i) are independent as memories and thus are capable of independently processing a command from the nonvolatile memory controller 73. The j nonvolatile memories 80 belong to ways (Way 1, Way 2, . . . , Way j) in the order physically closer to the nonvolatile memory controller (NVMC) 73. The nonvolatile memory controller 73 can determine whether the respective nonvolatile memories 80 are under data processing by acquiring signals of a ready/busy line (RY/BY) connected to the respective nonvolatile memories 80. The nonvolatile memory controller 73 is connected to the data control block 70 and can mutually communicate therewith.

Incidentally, a combination ij of a channel number i and a way number j can be used as an identifier to specify a chip of the nonvolatile memory 80.

Each of the DRAM controllers (DRAMC (1) to DRAMC (p)) 71-1 to 71-p is connected to the memories (DRAM (1) to DRAM (p)) 72-1 to 72-p and thereby reads data from the memory 72 and writes data to the memory 72. The DRAM controller 71 is connected to the data control block 70 and can mutually communicate therewith.

Incidentally, a data capacity of the nonvolatile memory 80 is larger than a data capacity of the DRAM 72. In other words, a data capacity per chip of the nonvolatile memory 80 is larger than a data capacity per chip of the DRAM 72. Furthermore, the example of employing the DRAM 72 is described in the example 1; however, a memory having a data transfer speed (the number of bytes to read or write per unit time) higher than that of the nonvolatile memory 80 may be employed.

### B. Configuration of Nonvolatile Memory and Read, Write, and Erase Processing

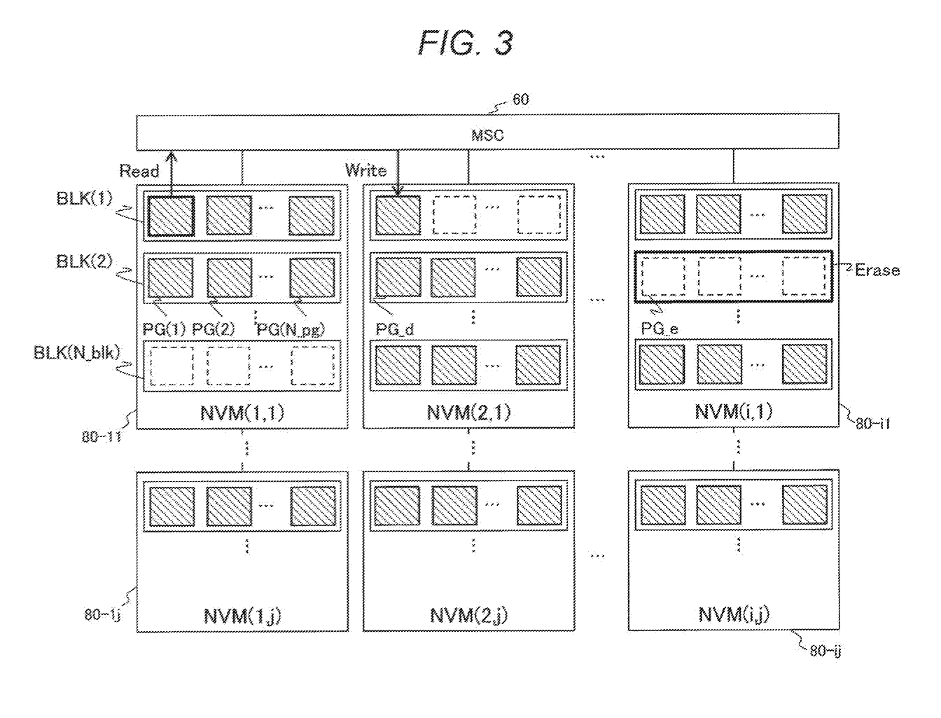

FIG. 3 is a block diagram illustrating an example of a configuration of a chip, a block, and a page of the nonvolatile memory 80 in the memory subsystem 50 and an object of read, write, and erase processing. A configuration of the nonvolatile memory 80 and the read, write, and erase processing of data will be described with FIG. 3.

Each of the nonvolatile memories 80 includes N_blk blocks (BLK) and each of the blocks includes N_pg pages (PG). Here, N_blk and N_pg represent natural numbers. For example, when the nonvolatile memory 80 is a NAND flash memory having a capacity of 8 GB/chip with a data size per block of 1 MB and a data size per page of 8 kB, N_blk=8k=(8 GB/1 MB) and N_pg=128=(1 MB/8 kB) hold.

Data stored in the nonvolatile memory 80 is read by pages (data size) and writing is performed by pages when data is written to the nonvolatile memory 80. Also, data stored in the nonvolatile memory 80 is erased by blocks (data size).

When data is written to the nonvolatile memory 80, overwriting data cannot be performed. For example, writing data to a page (PG_e) in a block (Erase in FIG. 3) erased in FIG. 3 can be performed, however, writing new data to a page (PG_d) already containing data cannot be performed. In summary, the nonvolatile memory 80 has the following two characteristics.

Characteristic 1: A data size of an erase unit (block) is larger than or equal to a data size of a write unit (page).

Characteristic 2: No new data can be overwritten to a page or the like already containing data.

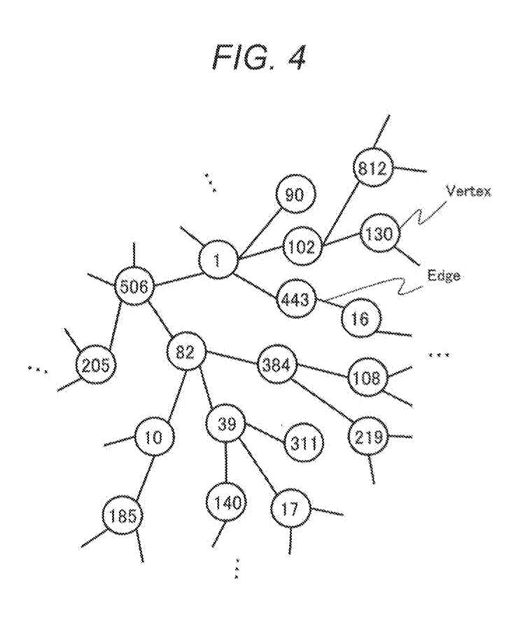

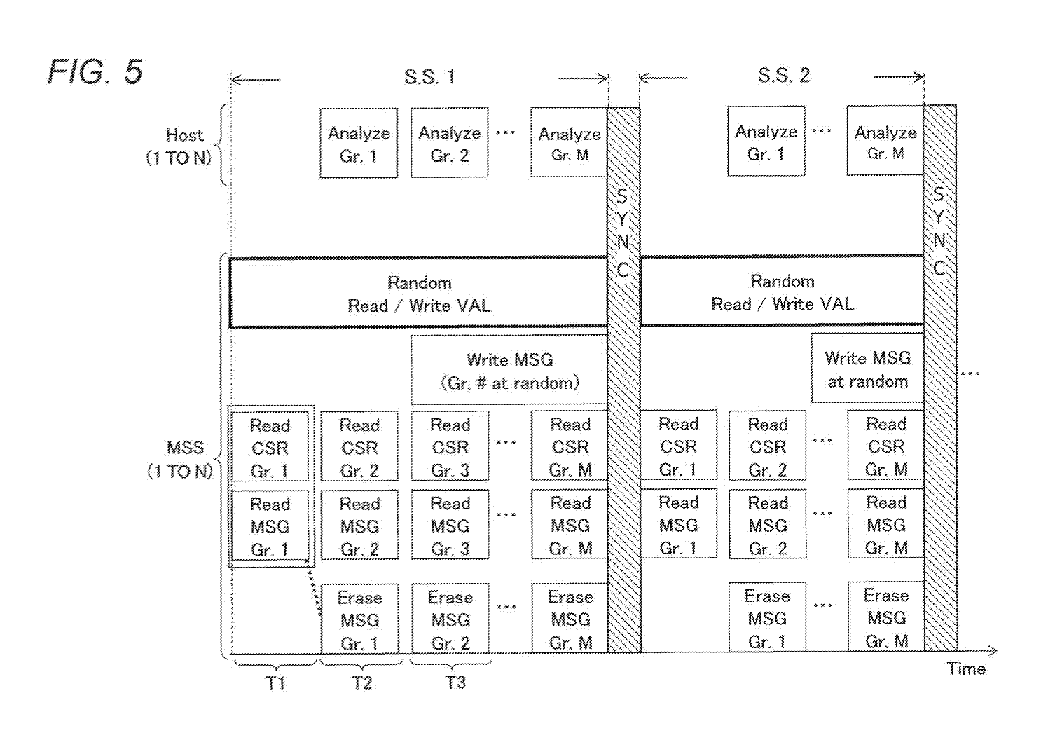

Hereinafter, processing performed by the server 10 will be described with an example of large-scale graph analysis. First, exemplary graphs handled by the server and exemplary analysis sequence of graph data will be described with FIGS. 4 and 5.

### C. Graph and Graph Analysis Sequence

FIG. 4 is a diagram illustrating an exemplary graph configuring big data handled by the server 10. In the graph illustrated here as an example, a vertex in the graph is allotted with a vertex number to uniquely specify each of the vertexes while an edge of the graph connecting two vertexes represents that there is a relationship between the two vertexes on both ends of the edge. The respective vertexes in the graph form graph data to be analyzed. Generally, vertexes of a graph to be analyzed in graph analysis amount to a huge number and thus graph data is classified into groups according to a vertex number and then analyzed by each group.

FIG. 5 illustrates an exemplary sequence of graph analysis executed in the server 10. The nonvolatile memory 80 of the memory subsystem (MSS) 50 stores graph data (CSR), a result of graph analysis (MSG), and vertex information (VAL), each of which is divided into groups (Gr), read or written and thereby processed by the host 30. The following sequence is performed in the N hosts 30 and memory subsystems 50 in a simultaneous and parallel manner. Incidentally, the group (Gr) refers to a collection of data classified according to the vertex number.

Time 1 (T 1): First, the memory subsystem 50 reads graph data belonging to a group 1 stored in the nonvolatile memory 80 (Read CSR Gr. 1), a result of graph analysis (Read MSG Gr. 1), and vertex information (Random Read/Write VAL) and sends to the host 30.

Reading the graph data (CSR) and the result of graph analysis (MSG) by the host 30 is sequentially performed by read units of the nonvolatile memory 80 while reading of vertex information (VAL) is, however, random access by a fine access unit of 16 bytes.

Time 2 (T2): Next, the host 30 analyzes the graph data of the group 1 sent from the memory subsystem 50 (Analyze Gr. 1). In parallel with this, the memory subsystem 50 reads graph data of a group 2 (Read CSR Gr. 2) and a result of graph analysis (Read MSG Gr. 2) to be subsequently analyzed by the host 30. In parallel with this, the memory subsystem 50 erases the result of graph analysis of the group 1 (Erase MSG Gr. 1). This result of graph analysis is not used again after analysis by the host 30 and thus can be erased at this timing.

Time 3 (T3): Each of the hosts 30 communicates the result of graph analysis of the group 1 to other hosts 30. Each of the hosts 30 gathers, by each group, results of graph analysis sent from other hosts 30 and sends the results to the memory subsystem 50. Simultaneously, each of the hosts 30 further sends an update result of vertex information to the memory subsystem 50.

The memory subsystem 50 writes the result of graph analysis of the data received from the host 30 to the nonvolatile memory 80 by a write unit of the nonvolatile memory 80 (Write MSG (Gr. # at random) in FIG. 5). Moreover, the update result of vertex information is sent to the memory subsystem 50 by a fine unit of 16 bytes and therefore the memory subsystem 50 executes read-modify-write processing where a write unit containing 16 bytes to be updated in the nonvolatile memory 80 is read, only the 16 bytes are updated, and writing by a write unit of the nonvolatile memory 80 is again performed. Alternatively, read-modify processing may be executed in the host 30 and a result thereof may be sent from the host 30 to the memory subsystem 50 by a write unit of the nonvolatile memory 80 (Random Read/Write VAL).

The above sequence is repeated in the order of groups. After processing of all the groups 1 to M is finished, synchronization of end of processing is executed among the respective hosts (Host (1) to Host (N)) 30-1 to 30-N(SYNC).

This series of processing and synchronization of the group 1 to M is referred to as a superstep (S.S.). The processing is repeated again from the group 1 in order after the synchronization. The result of graph analysis (MSG) written in the memory subsystem 50 in a previous super step is read by the host 30 in a subsequent superstep. Graph analysis is executed by repetition of this superstep.

### D. Communication Between Host and Memory Subsystem

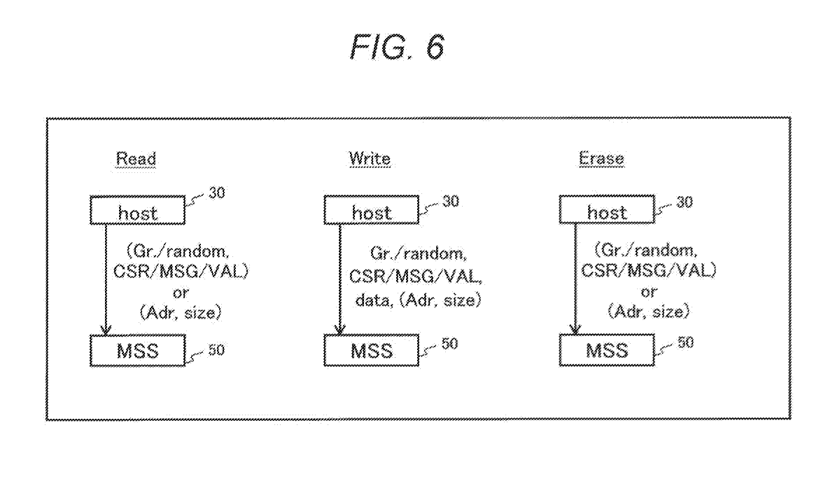

Communication between the host 30 and the memory subsystem 50 will be described with FIG. 6. FIG. 6 is a diagram illustrating information to send to the memory subsystem 50 when the host 30 sends a read, write, or erase command to the memory subsystem 50.

(a) Read

When the host 30 issues a read command (Read) of data in the memory subsystem 50, the host 30 sends, to the memory subsystem 50, the number of a group (Gr.) of data to read or metadata (random) representing that data is random access data, and a type of data (CSR/MSG/VAL). Alternatively, the host 30 sends a logical address (Adr) and read data size (size) to the memory subsystem 50. The memory subsystem 50 reads data from the nonvolatile memory 80 based on the information received from the host 30 and sends the read data to the host 30.

(b) Write

When the host 30 issues a write command (Write) of data to the memory subsystem 50, the host 30 sends, to the memory subsystem 50, the number of a group (Gr.) of data to write or metadata (random) representing that data is random access data, a type of data (CSR/MSG/VAL), data to write (data), and, as required, a logical address (Adr) and a data size to write (size). That is, the arithmetic module 40 of the host 30 notifies a write request including data to write and a type of data to the memory subsystem 50. The memory subsystem 50 writes the data to the nonvolatile memory 80 based on the information received from the host 30.

(c) Erase

When the host 30 issues an erase command (Erase) of data in the memory subsystem 50, the host 30 sends, to the memory subsystem 50, the number of a group (Gr.) of data to erase or metadata (random) representing that data is random access data, and a type of data (CSR/MSG/VAL). Alternatively, the host 30 sends a logical address (Adr) and a data size (size) to erase to the memory subsystem 50. The memory subsystem 50 erases the data in the nonvolatile memory 80 based on the information received from the host 30.

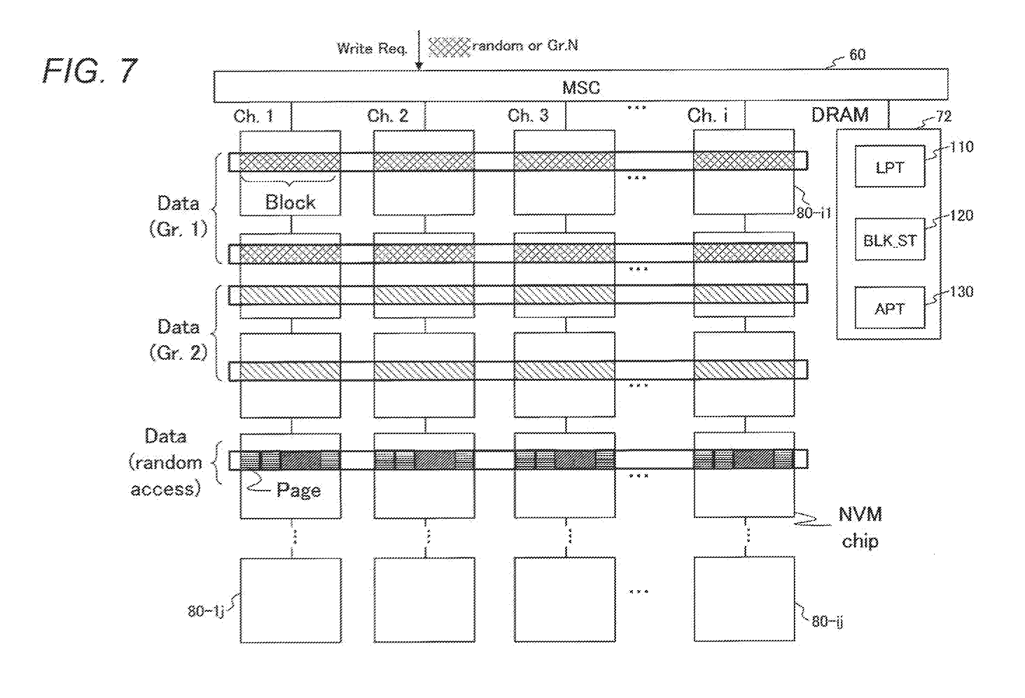

Next, processing in the memory subsystem 50 when the server 10 performs graph analysis processing will be described with FIGS. 7 to 18.

### E. Processing in Memory Subsystem Control Module Upon Graph Analysis

(E1) Input of Data Required for Control of Memory Subsystem 50

The host 30 to execute graph analysis writes data required for control of memory subsystem 50 to the register 61 of the memory subsystem 50 before graph analysis. The data required for control of memory subsystem 50 upon execution of graph analysis by the host 30 includes the number of groups, a data size of graph data, the number of vertexes or edges in the graph, rewrite frequency corresponding to a type of data (graph data, result, etc.), or the like. Moreover in a case of searching a shortest path in the graph, information specifying two vertexes between which the shortest path is to be obtained, that is a start point and an end point, is also included.

Incidentally, rewrite frequency corresponding to a type of data may be specified at a source level of a program to analyze the graph. For example, setting a period of storing data in the nonvolatile memory 80 at the source level allows the host 30 to communicate a rewrite frequency of data to the memory subsystem 50.

Furthermore, data to write in the register 61 includes, for example, the number of groups of graph data to be analyzed.

Input of the data may be executed by a program executed by the host 30 or performed by writing, by the host 30 to the register 61, data received by the server 10 from an external computer.

(E2) Data Write Processing

Control upon writing data to the memory subsystem 50 will be described with FIGS. 7 to 10.

FIG. 7 is a block diagram illustrating exemplary correspondence relation among the chip, the block, and the page of the nonvolatile memory 80, the data group, and random access data.

First as illustrated in FIG. 7, when sending a write request to the memory subsystem control module (MSC) 60, the host 30 adds metadata containing attributes (random access data, group number, etc.) of data (random or Gr. N) in addition to a write command and data to write.

Meanwhile, the memory subsystem control module (MSC) 60 stores various management tables in the DRAM 72 of the memory subsystem 50, refers to the management table based on the attributes of data (metadata) sent from the host 30, and determines a writing destination of the data.

Incidentally, FIG. 7 illustrates an example where a logical/physical conversion table (LPT) 110, an attribute physical conversion table (APT) 130, and a block management table (BLK_ST) 120 are stored in the DRAM 72 as the management tables.

A writing destination by each data attribute may be arranged in a distributed manner to the respective channels (Ch. 1 to Ch. i) of the nonvolatile memory 80 as illustrated in FIG. 7. In the example of FIG. 7, storing destinations of data in one group are set across channels Ch. 1 to Ch. i having the same way number, where access is performed in a parallel manner. Incidentally, one group may be allotted to the plurality of way numbers.

Furthermore, random access data is stored in different blocks from the blocks in the chip of the nonvolatile memory 80 storing the data of the group and is set across channels Ch. 1 to Ch. i having the same way number. Similarly, random access data may be allotted to the plurality of way numbers. Incidentally, the memory subsystem control module 60 dynamically changes a write area of the nonvolatile memory 80 according to a size of data of a write request. The memory subsystem control module 60 changes the channels Ch. 1 to i according to a size of data to write.

With the configuration in FIG. 7, an area, to store graph data (CSR) and a result of graph analysis (MSG) where reading by the host 30 is sequential, is set across the plurality of channel numbers by each group. Also, an area to store vertex information (VAL) where reading by the host 30 is random access is set to a chip or block different from that of the group. This allows for preventing data of random access and data of sequential access from being stored in a mixture in one block of the nonvolatile memory 80. Like in the aforementioned conventional example, therefore, this prevents data of sequential access from being moved and erased together with data of random access, thereby enhancing efficiency of garbage collection in the nonvolatile memory 80.

Furthermore, reading the graph data (CSR) allotted to the group and a result of graph analysis (MSG) is sequentially performed by a read unit of the nonvolatile memory 80 and therefore setting across the plurality of channel numbers by groups can enhance parallelism of access and enhance data transfer speed.

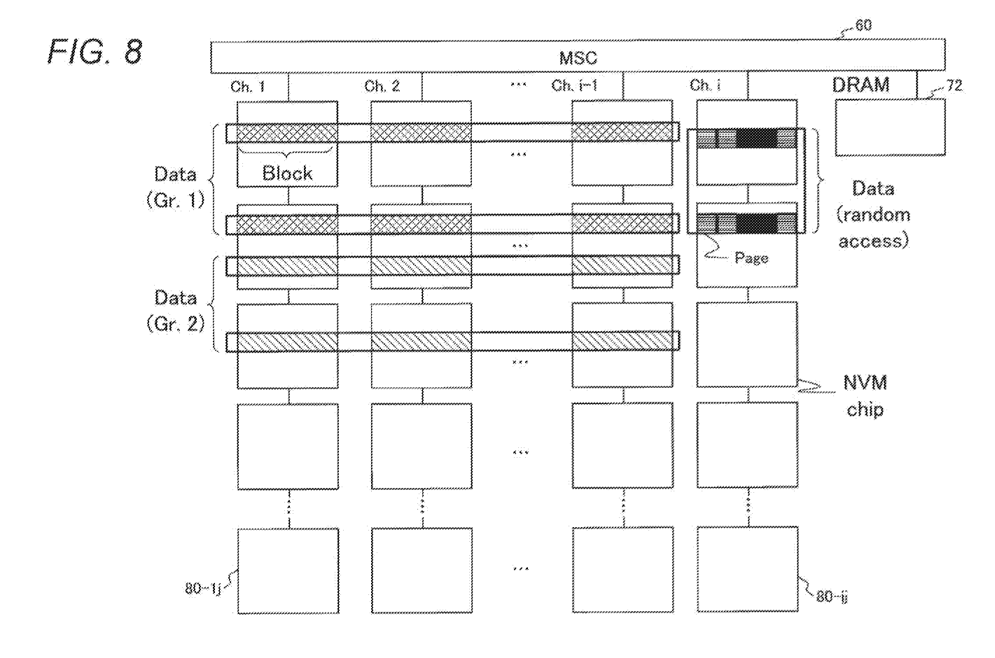

Alternatively as illustrated in FIG. 8, random access data and data added with a group number may be written in separate channels or chips.

Incidentally, FIG. 8 is a block diagram illustrating other exemplary correspondence relation among a chip, a block, and a page of the nonvolatile memory 80, a data group, and random access data. In FIG. 8, the channels Ch. 1 to Ch. i-1 to store data allotted to a group is configured by a NAND flash memory such as a multiple level cell (MLC) while the channel Ch. i to store data of random access is configured by a chip having a long rewrite lifetime such as a NAND flash memory of a single level cell (SLC) or ReRAM.

This case also allows for preventing data of random access and data of sequential access from being stored in a mixture in one block of the nonvolatile memory 80. Like in the aforementioned conventional example, therefore, this prevents data of sequential access from moved and erased together with data of random access, thereby enhancing efficiency of garbage collection in the nonvolatile memory 80.

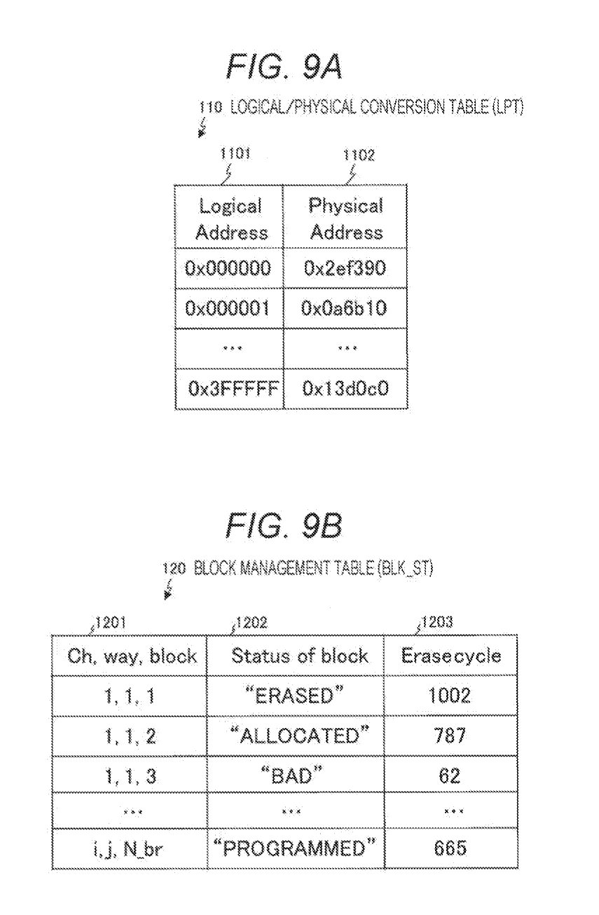

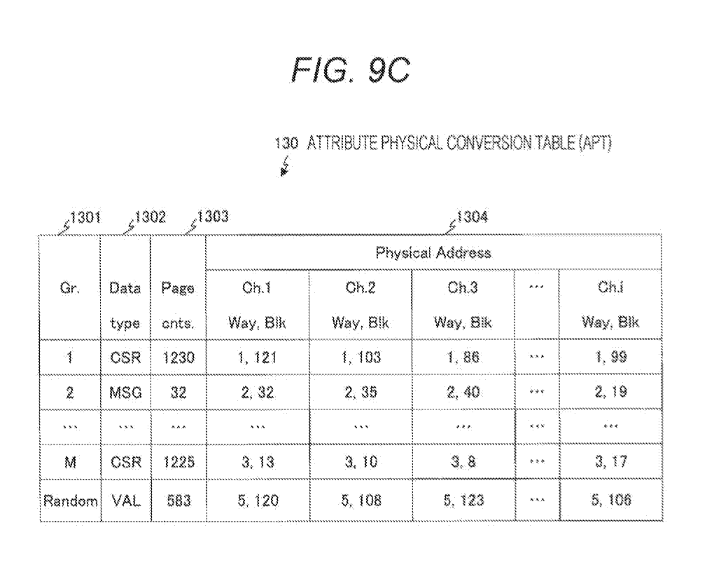

The management tables required for data write processing are illustrated in FIGS. 9A to 9C. These management tables are set to the DRAM 72 by the memory subsystem control module (MSC) 60 before initiation of graph data analysis.

FIG. 9A is a logical/physical conversion table (LPT) 110 to map a logical address 1101 and a physical address 1102 of data. This example illustrates an example where the memory subsystem control module (MSC) 60 manages an address by pages, where each page has 8 k bytes, where the logical address 1101 and physical address 1102 specify an address of the head of each page.

FIG. 9B is a diagram illustrating an exemplary block management table (BLK_ST) 120. The block management table 120 includes, in one record, a block location 1201, a status of block 1202, and an erase cycle 1203 of the block. The block location 1201 includes a channel number (i), a way number (j), and a block number N_br. As for the status of block 1202, a preset status such as erased “ERASED”, allocated as a writing destination “ALLOCATED”, a defective block “BAD”, and written with data “PROGRAMMED” is stored. The erase cycle 1203 is added with one each time the block is erased.

FIG. 9C is a diagram illustrating an exemplary attribute physical conversion table (APT) 130 for management of writing destinations by each data attribute. The attribute physical conversion table 130 includes, in one entry, a group 1301 to store groups of data, a data type 1302 to store types of data, a page count 1303 to store the number of pages already written with data, and a physical address 1304 of blocks 1 to i to subsequently store data of the group.

The group 1301 stores group numbers (1 to M) or “Random” representing that data is of random access. The data type 1302 stores graph data (CSR), a result of graph analysis (MSG), or vertex information (VAL). The page count 1303 stores, for each data type, the number of pages already written in. The physical address 1304 stores the channel number, the way number, and the block number N_br and further stores, by each data type, a block number to subsequently store data.

This attribute physical conversion table (APT) 130 is set by the memory subsystem control module (MSC) 60 according to a configuration or the like of the nonvolatile memory 80. Incidentally, the group 1301 is set by the memory subsystem control module (MSC) 60 based on the number of groups written in the register 61.

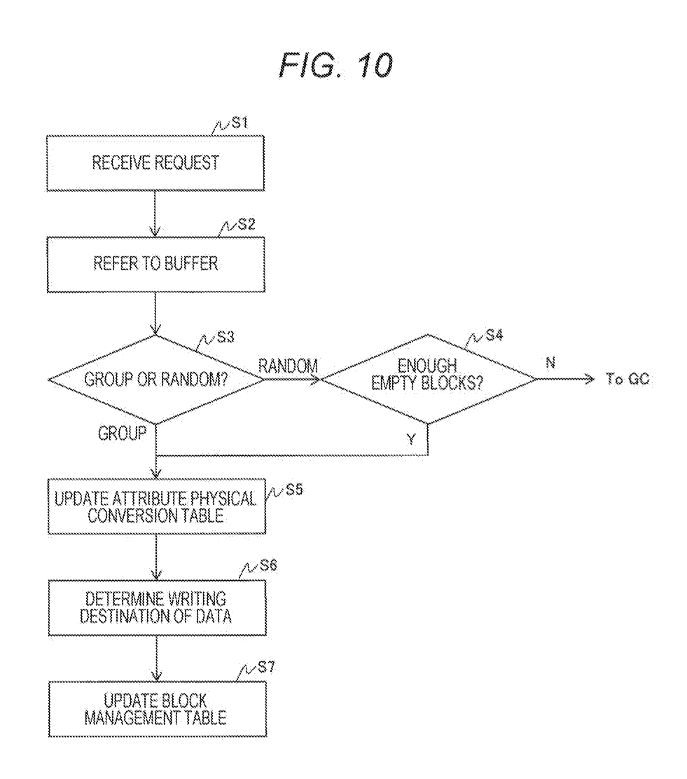

FIG. 10 is a flowchart illustrating exemplary data write processing executed by the memory subsystem 50. First, the data control block (D-CTL_BLK) 70 of the memory subsystem control module (MSC) 60 refers to the register (RG) 61 and receives a data write request from the host 30 (step S1). The data control block (D-CTL_BLK) 70 stores a command, data, an address, and metadata included in the data write request received from the host 30 in the command buffer (C-BF) 66, the data buffer (D-BF) 65, the address buffer (A-BF) 64, and the metadata buffer (M-BF) 63, respectively.

Thereafter, the data classification block (CLSFY_BLK) 68 refers to the metadata buffer (M-BF) 63 (step S2) and determines whether the received data is added with a group number or random access data (step S3).

In a case of random access data, the flow proceeds to step S4 where the data classification block (CLSFY_BLK) 68 refers to the block management table 120 and determines whether enough empty blocks remain, that is, whether the number of empty blocks remains larger than or equal to a threshold value (Th 1) (step S4).

The threshold value (Th 1) of the number of empty blocks is determined by the host 30 in advance and is notified to the memory subsystem 50 before writing data. Alternatively, the threshold value (Th 1) is determined by the memory subsystem control module (MSC) 60 based on history of data access, a capacity of the nonvolatile memory 80, data, required for control, written in the register 61 in the above step (E1), and the like.

When the number of empty blocks remains larger than or equal to the threshold value (Th 1) in step S4, the flow proceeds to step S5. On the other hand, when the number of empty blocks does not remain larger than or equal to the threshold value (Th 1), the memory subsystem control module (MSC) 60 executes garbage collection (GC) and increases the number of empty blocks. Incidentally, after garbage collection (GC) is completed, the flow returns to step S4. Incidentally, as for processing of garbage collection, a well-known or publicly known technique can be applied and thus illustration thereof is omitted.

In step S5, first the data classification block (CLSFY_BLK) 68 refers to a row corresponding to a corresponding data classification in the attribute physical conversion table (APT) 130 in FIG. 9C. The data classification block (CLSFY_BLK) 68 then adds 1 to the page count 1303 in the corresponding row.

When the page count 1303 exceeds a predetermined threshold value (Th 2) as a result of adding, the data control block 70 refers to the block management table (BLK_ST) 120 in FIG. 9B and select the empty block “ERASED” in the nonvolatile memory 80 one by one from each of the chips (channels Ch. 1 to Ch. i), thereby using as a new writing destination. The threshold value (Th 2) is, for example, a total number of pages of the nonvolatile memory 80 included in the i blocks included in one row of the physical address 1304. The data control block (D-CTL_BLK) 70 updates, with the selected i block numbers, channel numbers, and way numbers, the physical address 1304 of the attribute physical conversion table (APT) 130 with respect to the group where writing has been currently performed.

The data control block (D-CTL_BLK) 70 further updates, with respect to the selected block, a status of the block stored in the block management table (BLK_ST) 120 from “ERASED” to “ALLOCATED” and updates a value of the page count 1303 in a corresponding row in the attribute physical conversion table (APT) 130 to 1 (step S5).

Next in step S6, the data control block (D-CTL_BLK) 70 determines a writing destination of the data. First, the data classification block (CLSFY_BLK) 68 refers to items of the page count 1303 and physical address 1304 of the corresponding data classification of the attribute physical conversion table (APT) 130. Thereafter, from the value of the page count 1303, the data classification block (CLSFY_BLK) 68 selects i writing destinations, as the chip (i, j), the block (N_blk), and the page (N_pg) of a subsequent writing destination, stored in the items of the physical address 1304 of the attribute physical conversion table (APT) 130.

The data classification block (CLSFY_BLK) 68 then sends a write request to the nonvolatile memory controllers (NVMC) 73-1 to 73-i of the channel (Ch. i) to control the chip (i, j) of the selected writing destination. The nonvolatile memory controller 73 having received the write request writes a value of the data buffer (D-BF) 65 in the specified page (N_pg) of the block (N_blk) of the chip (i, j).

The data classification block (CLSFY_BLK) 68 then updates the logical/physical conversion table (LPT) 110 in FIG. 9A while mapping a logical address corresponding to the physical address 1304 where writing has been performed and then updates the status of block 1202 in the row of the block where writing has been performed in the block management table 120 illustrated in FIG. 9B from “ALLOCATED” to “PROGRAMMED” (step S7).

The above processing allows for storing graph data (CSR) and a result of graph analysis (MSG), where reading by the host 30 is sequential, in the nonvolatile memory 80 across the plurality of channel numbers by groups and writing vertex information (VAL) where reading by the host 30 is random access to a chip or block (erase unit) different from that of the group.

This allows for preventing data of random access and data of sequential access from being stored in a mixture in one block of the nonvolatile memory 80. That is, data of random access and data other than random access data (data of sequential access) can be managed in different blocks (erase units) of the nonvolatile memory 80. Like in the aforementioned conventional example, therefore, this prevents data of sequential access from being moved and erased together with data of random access, thereby enhancing efficiency of garbage collection in the nonvolatile memory 80.

Furthermore, reading the graph data (CSR) allotted to the group and a result of graph analysis (MSG) is sequentially performed by a read unit of the nonvolatile memory 80 and therefore setting across the plurality of channel numbers by groups can enhance parallelism of access and enhance data transfer speed.

Incidentally, the example 1 illustrates an example where the memory subsystem control module (MSC) 60 sets the attribute physical conversion table (APT) 130; however, the memory subsystem control module 60 may notify a configuration of the nonvolatile memory 80 to the host 30 and a program executed by the host 30 may set the attribute physical conversion table 130.

### Example 2

The example 1 illustrates an example where the memory subsystem control module (MSC) 60 stores the data of the write request to the nonvolatile memory 80 in an uncompressed manner; however, the present example 2 illustrates an example of compressing data.

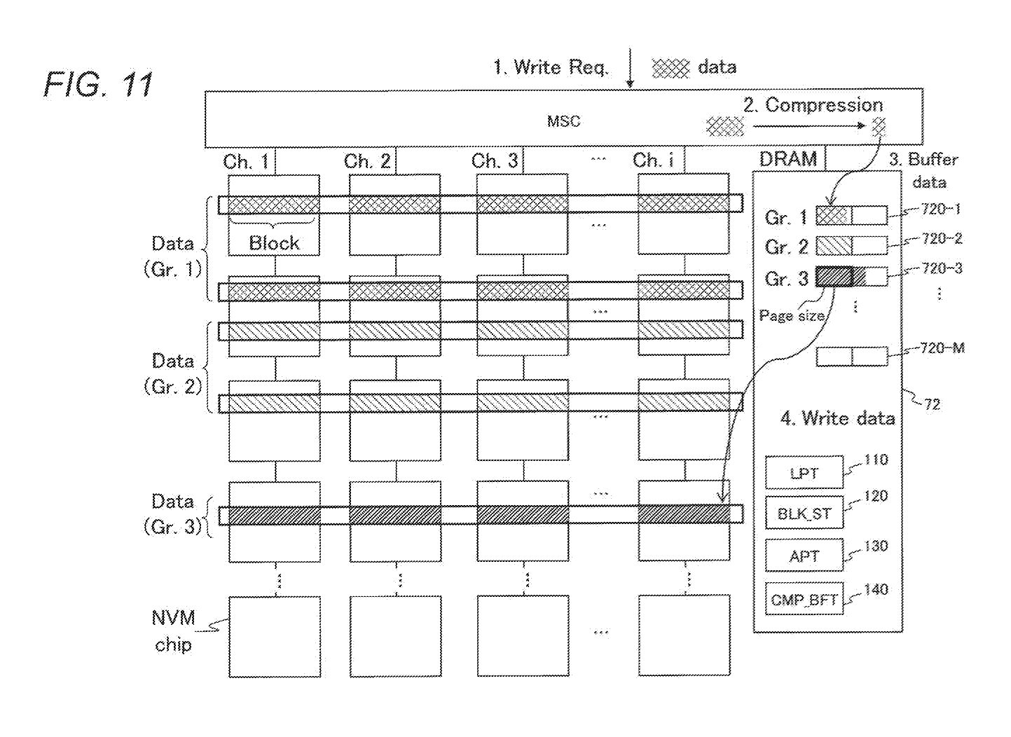

FIG. 11 is a block diagram illustrating exemplary correspondence relation among a chip, a block, and a page of a nonvolatile memory and a group of compressed data of the example 2. A DRAM 72 stores, in addition to the tables illustrated in the example 1, buffers 720-1 to 720-M for groups (1 to M), respectively, and a DRAM buffer management table 140. Other configurations are similar to those of the example 1 and thus overlapping descriptions thereon are omitted.

The buffers 720-1 to 720-M are storage areas to temporarily store compressed data by each of the groups 1 to M after a memory subsystem control module (MSC) 60 compresses data to write having received from a host 30.

The DRAM buffer management table 140 manages compressed data stored in the buffers 720-1 to 720-M.

Control upon writing compressed data in a memory subsystem 50 will be described with FIGS. 11 to 14B.

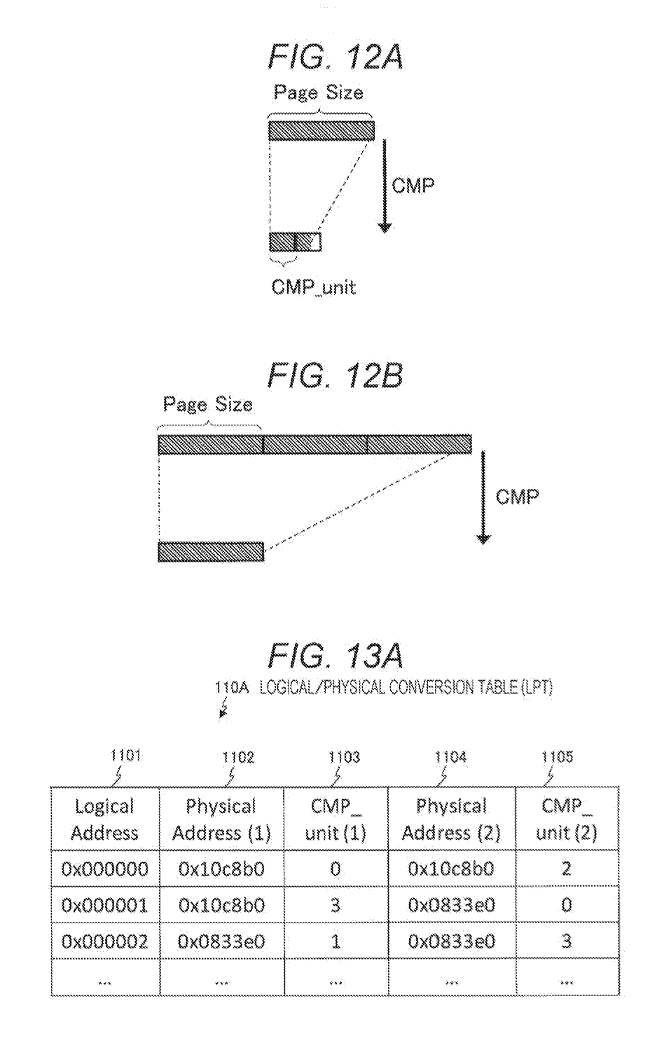

First, overall control will be briefly described with FIGS. 11, 12A, and 12B. The memory subsystem control module (MSC) 60 receives data and a write request from the host 30 (1. Write Req. in FIG. 11).

The memory subsystem control module (MSC) 60 compresses data sent from the host 30 (2. Compression in FIG. 11). Whether to compress the data may be determined by whether the host 30 sends a compression request in addition to the write request of the data or determined by the memory subsystem control module (MSC) 60.

FIG. 12A is a diagram illustrating an exemplary change of a data size before and after data compression processing. As illustrated in FIG. 12A, when the data is sent by a write unit (PAGE SIZE) of a nonvolatile memory 80 from the host 30, compressed data is managed by a compressed data size unit (CMP_unit) smaller than the write unit (page) of the nonvolatile memory 80. When a page size is 8K bytes, this compressed data size unit (CMP_unit) is managed by 2K bytes for example where one page size is managed by four compressed data size units.

Thereafter, the compressed data is buffered, for physical addresses different by each group of data, in the buffers 720-1 to 720-M set in the DRAM 72 of the memory subsystem 50 by the memory subsystem control module (MSC) 60 (3. Buffer Data in FIG. 11).

When a size of data buffered by each group of data exceeds the page (write unit) size of the nonvolatile memory 80, the memory subsystem control module (MSC) 60 writes the compressed data to the nonvolatile memory 80 by a predetermined write unit based on the flowchart of the data write processing illustrated in FIG. 7 of the example 1 (E2).

FIG. 12B is a diagram illustrating an exemplary change of a data size before and after data compression processing. Meanwhile, as illustrated in FIG. 12B, when the data is sent by write unit (PAGE SIZE) of the plurality of nonvolatile memories 80 from the host 30, the memory subsystem control module (MSC) 60 adjusts the compressed data to the write unit of the nonvolatile memory 80 and thereby writes the data. When a compressed data size reaches the page size, the compressed data is not buffered in the buffers 720-1 to 720-M of the DRAM 72 while the memory subsystem control module (MSC) 60 directly writes the compressed data to the nonvolatile memory 80 by the write unit of the nonvolatile memory 80 based on the flowchart of the data write processing illustrated above (E2).

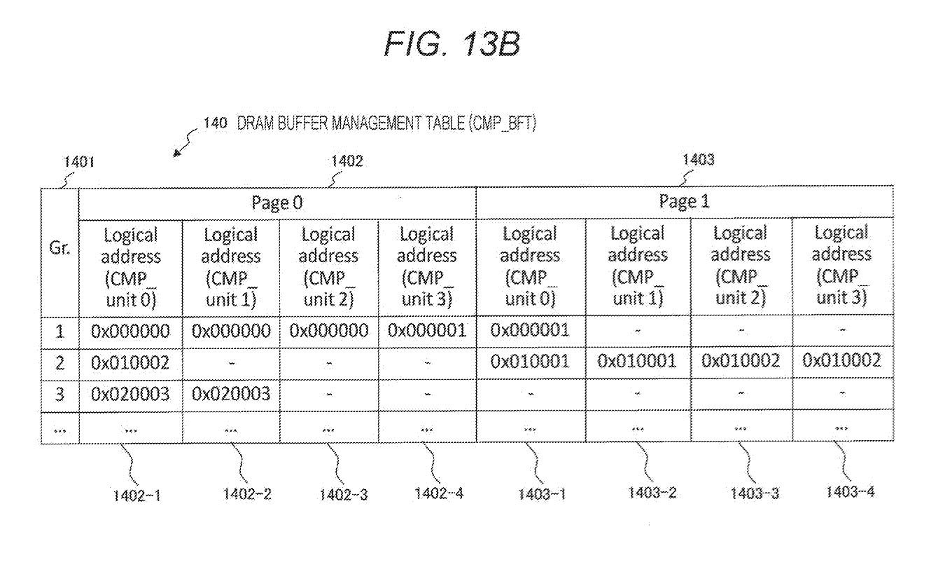

Management tables required for data compression and write processing are illustrated in FIGS. 13A and 13B. FIG. 13A is a logical/physical conversion table (LPT) 110A to map a logical address and a physical address of data. In the example 2, unlike the logical/physical conversion table 110 illustrated in FIG. 9A, a data size corresponding to one logical address is variable upon data compression. Therefore, a physical address storing data corresponding to one logical address is managed while divided into compressed data size units (CMP_unit) which are smaller than the write unit of the nonvolatile memory 80. The logical/physical conversion table (LPT) 110A in FIG. 13A includes, in one record, a logical address 1101, a physical address 1102 to represent a starting location of compressed data, a compression unit 1103 to represent a starting location of compressed data, a physical address 1104 to represent a location of a page that is an end point of compressed data, and a compression unit 1106 that is an end point of compressed data.

For example in the example of FIG. 13A, one write unit (page) of the nonvolatile memory 80 is divided into four compressed data size units (CMP_unit). It is shown that data of a logical address 0x000000 in the first row is stored from the zeroth compressed data size unit (CMP_unit) of a physical address (corresponds to the write unit of the nonvolatile memory 80) 0x10c8b0 to the second compressed data size unit (CMP_unit) of the same physical address (page) 0x10c8b0. Others are likewise.

FIG. 13B is a DRAM buffer 1 management table (CMP_BFT) 140 to temporarily store compressed data. The DRAM buffer management table 140 manages buffering of two pages of pages 0 and 1 according to that the buffers 720-1 to 720-M illustrated in FIG. 11 are set to have a capacity of two pages. The DRAM buffer management table 140 includes, in one record, a group 1401 to store a group number, logical addresses 1402-1 to 1402-4 of compressed data size units (CMP_units 0 to 3) of the page 0, and logical addresses 1403-1 to 1403-4 of compressed data size units (CMP_units 0 to 3) of the page 1.

The memory subsystem control module (MSC) 60 stores data in the buffers 720-1 to 720-M of the DRAM 72 by groups. FIG. 13B illustrates an example where a data area of two write units of the nonvolatile memory 80 is secured in the buffer 720 of each group. The write unit of the nonvolatile memory 80 is further divided into four compressed data size units (CMP_unit) and thus the logical addresses 1402-1 to 1402-4 corresponding to the data are stored in the DRAM buffer management table 140 by each compressed data size unit (CMP_unit). In the example FIG. 13B, the example of the table storing logical addresses corresponding to each compressed data is described; however, for example the logical address may be added to the head of compressed data and the logical address may be stored in the DRAM buffer 720 together with the compressed data.

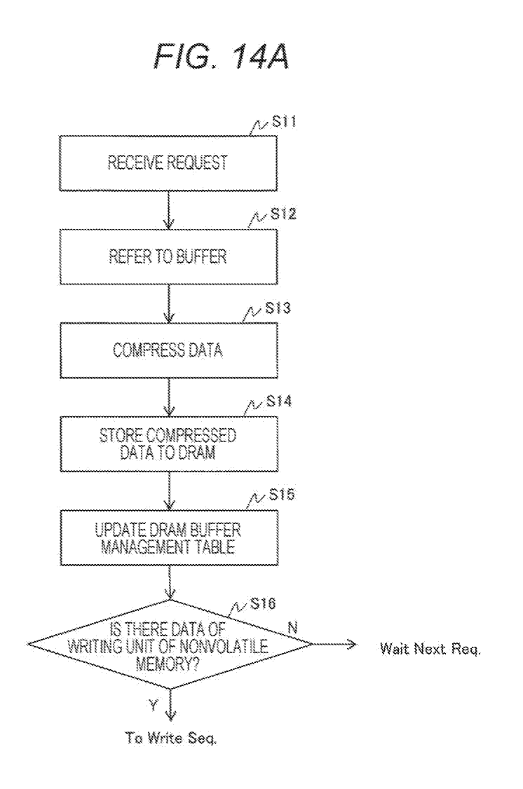

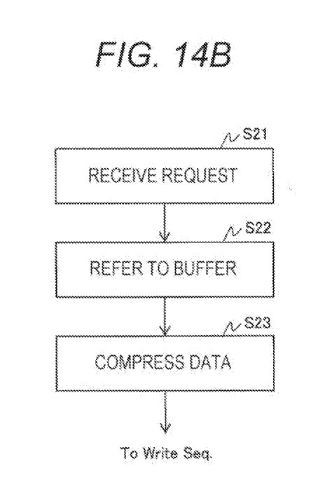

FIGS. 14A and 14B are flowcharts illustrating exemplary data compression and write processing preformed in the memory subsystem 50.

FIG. 14A is a flowchart of processing performed in the memory subsystem 50 when data is sent from the host 30 by the write unit (PAGE SIZE) of the nonvolatile memory 80.

First, the data compression block (COMP_BLK) 69 of the memory subsystem control module (MSC) 60 refers to the register 61 and receives a data write request from the host 30 (step S1).

Next, the data compression block (COMP_BLK) 69 refers to an attribute of the data (or group of the data) of the write request stored in the metadata buffer (M-BF) 63 (step S12). The data compression block (COMP_BLK) 69 then compresses the data stored in the data buffer (D-BF) 65 (step S13).

The data compression block (COMP_BLK) 69 stores the compressed data in the buffer 720 of the DRAM 72 of the memory subsystem 50. As for a storing destination of the compressed data, selection is made from among the buffers 720-1 to 720-M according to the group of the data having been referred to in step S12.

The data compression block (COMP_BLK) 69 then acquires a logical address of the data stored in an address buffer (A-BF) 64. The data compression block (COMP_BLK) 69 updates the DRAM buffer management table (CMP_BFT) 140 of the memory subsystem 50 based on a value of the acquired logical address of the data (step S15). In this update, the acquired logical address is written to a page of the buffer 720 written with the compressed data and compressed data size units (CMP_units 0 to 3).

The data compression block (COMP_BLK) 69 refers to the DRAM buffer management table (CMP_BFT) 140 and determines whether data of the group where writing has currently been performed is accumulated, in the buffer 720, by the write unit of the nonvolatile memory 80 (step S16).

When, as a result of the determination, compressed data is accumulated in the buffer 720 by the write unit (one page) of the nonvolatile memory 80, the write processing illustrated in FIG. 10 of the example 1 is executed and the compressed data in the buffer 720 is written to the nonvolatile memory 80 (To Write Seq.).

On the other hand, when, as a result of the determination, compressed data is not accumulated in the buffer 720 by the write unit (one page) of the nonvolatile memory 80, the data compression block (COMP_BLK) 69 transfers to a state of waiting for a next request from the host 30 (Wait Next Req.).

Incidentally, the example of storing in the buffers 720-1 to 720-M for each group of data has been described in the above; however, although not illustrated, data of random access is also compressed with a buffer provided to the DRAM 72 in a similar manner to the above.

As a result of the above processing, the data compression block 69 compresses the data to write having been received from the host 30, thereby accumulates in the buffer 720, and writes to the nonvolatile memory 80 when data of one page is accumulated in the buffer 720. A writing destination of data is similar to the example 1. By separating a block of the nonvolatile memory 80 to store data of sequential access and a block to store data of random access and further compressing data, a storage area of the nonvolatile memory 80 can be effectively utilized.

FIG. 14B is a flowchart of processing performed in the memory subsystem 50 when data is sent from the host 30 by the plurality of write units (PAGE SIZE) of the nonvolatile memory 80. That is, as illustrated in FIG. 12B, processing where compression of the plurality of pages results in one page.

Steps S21 to S23 are similar to FIG. 14A. After compression of data, the compressed data is not stored in the buffer 720 of the DRAM 72 but is written by the write unit of the nonvolatile memory 80 according to the data write processing illustrated in FIG. 10 of the example 1.

In this manner, the example 2 allows for enhancing efficiency of utilization of the nonvolatile memory 80 by compressing data in addition to the effects of the example 1.

Incidentally, although not illustrated, the data compression block 69 decompresses compressed data when the host 30 reads the compressed data.

### Example 3

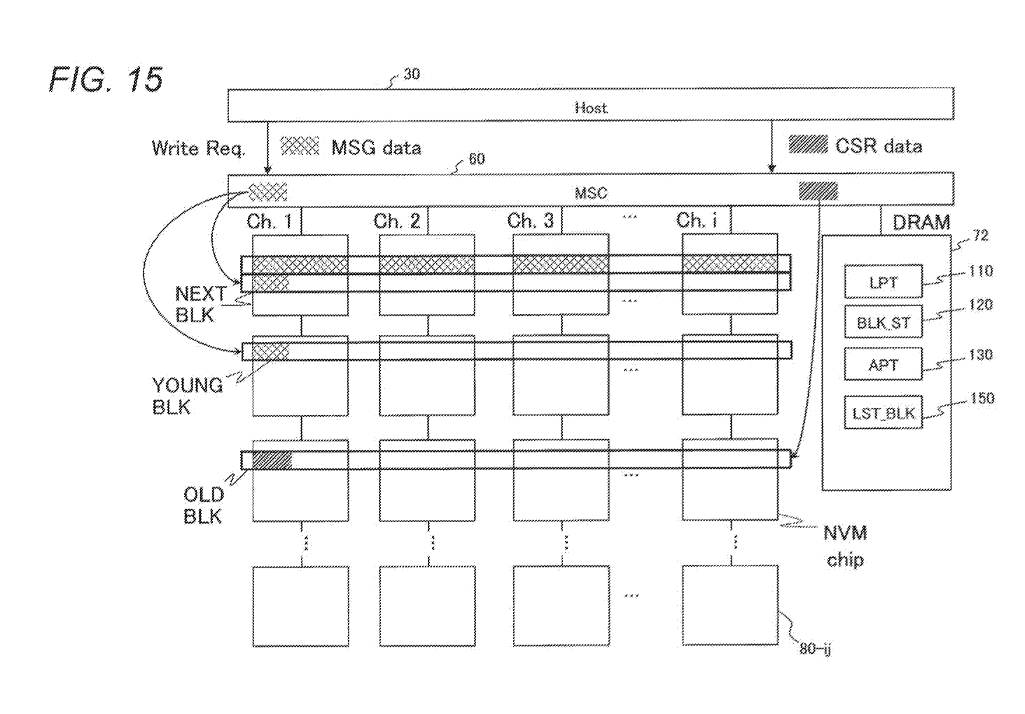

FIGS. 15 to 18 illustrate an example 3 where a last writing block management table 150 is added to the configuration of the example 1 and a writing destination is selected upon writing data to the memory subsystem 50.

First, overall processing will be described with FIG. 15. FIG. 15 is a block diagram illustrating exemplary correspondence relation among a chip and a block in a nonvolatile memory and a stored data type.

Together with a write request and data, a type of data (graph data (CSR), analysis result (MSG), vertex information (VAL), etc.) is notified from the host 30 to a memory subsystem control module (MSC) 60. The memory subsystem control module (MSC) 60 changes a method of selecting a writing destination of the data based on the type of the data received.

In the example where graph data (CSR) is not updated until termination of graph processing as illustrated in FIG. 5 of the example 1, the graph data is not updated during the graph processing but an analysis result (MSG) of the graph processing is updated for each superstep (S.S.). Moreover, the vertex information (VAL) is updated randomly by a fine access unit of, for example 16 bytes.

Therefore, the memory subsystem control module (MSC) 60 writes graph data (CSR) having a low update frequency to a block (OLD BLK) having a relatively large erase cycle (as compared to an overall mean of the memory subsystem 50) while writing an analysis result (MSG) or the like having a high update frequency to a block (YOUNG BLK) having a small erase cycle or a block (physically) next to a block where writing has been performed most recently (NEXT BLK).

Changing selection of a writing destination according to the type of data allows for correcting bias of the erase cycle among different blocks, lowering a frequency of static wear levelling or the like, thereby enhancing performance or lifetime of the nonvolatile memory 80.

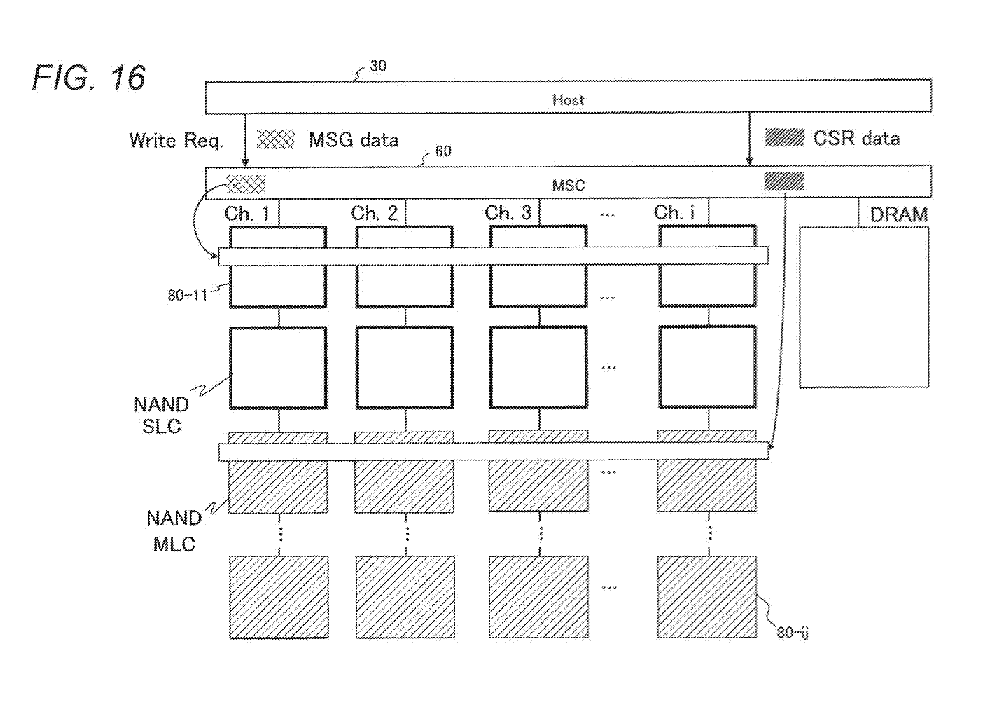

FIG. 16 is a block diagram illustrating other exemplary correspondence relation among a chip and a block in a nonvolatile memory and a stored data type.

As in FIG. 16, when the memory subsystem 50 includes devices (nonvolatile memories) having different upper limits (rewrite lifetime) of the number of times of rewriting in a mixture, graph data (CSR) having a low update frequency is stored in a NAND MLC having a low upper limit of the erase cycle while an analysis result (MSG) or the like having a high update frequency is stored in a NAND SLC having a high upper limit of the erase cycle. This allows for equalizing lifetimes among different devices, thereby enhancing a lifetime of the entire memory subsystem 50.

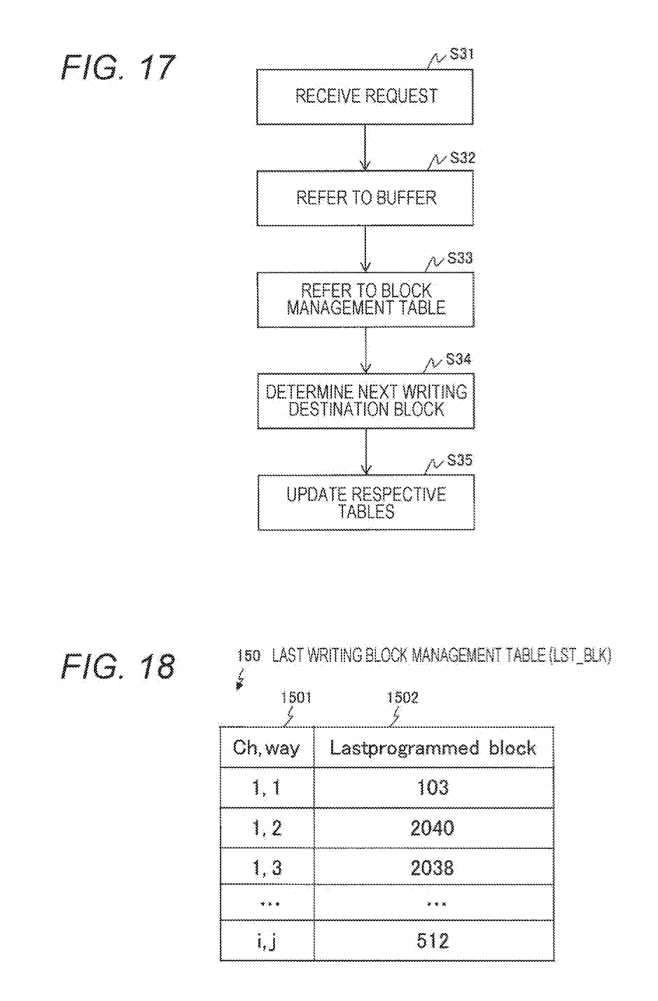

Next, a flowchart of processing of writing destination selection will be described with FIG. 17. First, the memory subsystem control module (MSC) 60 receives a write request from the host 30 (step S31).

Next, a wear-leveling block (WL_BLK) 67 of the memory subsystem control module (MSC) 60 refers to the type of data stored in the metadata buffer (M-BF) 63 (step S32). The wear-leveling block (WL_BLK) 67 then refers to the block management table (BLK_ST) 120 illustrated in FIG. 9B of the example 1 or the last writing block management table (LST_BLK) 150 illustrated in FIG. 18 stored in the DRAM 72 of the memory subsystem 50 (step S33). Thereafter, the wear-leveling block (WL_BLK) 67 acquires the erase cycle (Erase cycle) of the nonvolatile memory 80, a block number where the writing to a chip of each channel and way has been performed most recently (Last programmed block).

The wear-leveling block (WL_BLK) 67 determines a next writing destination block based on the acquired information and the type of data having been referred to in step S32 (step S34). As for determination on the next writing destination block, processing described in FIG. 15 or 16 is performed.

Thereafter, the wear-leveling block (WL_BLK) 67 sends a write request to the nonvolatile memory controller NVMC 73 of a channel where a chip of the writing destination belongs. Moreover, the wear-leveling block (WL_BLK) 67 updates, of the block management table (BLK_ST) 120, a status of block (Status of block) 1202 in a row of a corresponding data type from “ERASED” to “ALLOCATED” or “PROGRAMMED” and further updates the last writing block management table (LST_BLK) 150, attribute physical conversion table (APT) 130, and logical/physical conversion table (LPT) 110 (step S35).

The above processing allows for, in addition to the effects of the example 1, correcting bias of the erase cycle among different blocks by changing selection of a writing destination according to the type of data, lowering a frequency of static wear levelling or the like, thereby enhancing performance or lifetime of the nonvolatile memory 80.

### F. Summary of Effects

Main effects obtained from the configurations and processing of the respective examples 1 to 3 as described above are as follows.

Allowing for using a nonvolatile memory of a low cost with a large capacity allows for providing, at a low cost, a large-scale memory required for processing a large amount of data such as big data as well as performing high-speed data access on the memory. That is, in a server to perform high-speed processing of big data, data is stored in the nonvolatile memory 80 such as a NAND flash memory having a bit cost lower than a DRAM or the like and even in this case data of random access and other data are stored in different erase units (e.g. block) of the nonvolatile memory 80. This allows for enhancing efficiency of garbage collection in the nonvolatile memory 80, thereby enabling high-speed data access. Also, compressing data in the memory subsystem 50 and buffering the compressed data by each classification of data in a high-speed memory though with a small capacity such as a DRAM allow for reducing data access to the nonvolatile memory 80, thereby enabling high-speed data access. Moreover, switching, by a storage device, methods of selecting a writing destination by each classification of data allows for leveling the erase cycle of the nonvolatile memory 80, thereby allowing for suppressing deterioration of lifetime of the storage device.

Furthermore in the above description, the example of the server 10 including the host 30 to perform data processing, the nonvolatile memory 80, and the memory subsystem control module 60 to manage the nonvolatile memory 80 has been described; however, the server 10 may include the host 30 to manage data analysis and the nonvolatile memory 80 and the memory subsystem control module 60 to control the nonvolatile memory 80 according to management by the host 30.

Also, the example where a large-scale graph is classified into a plurality of groups (Gr.) and random access or graph data and analysis result depending on a vertex number or a type of data and thereby managed has been described; however in an example where the graph data itself is frequently updated, update graph data may be handled as another classification and processing of a large-scale graph or big data processing to be handled is not limited to the examples above. For example in MapReduce processing, memory processing may be performed similarly to the above processing such as, big data (controlled by keys and values) may be divided into a plurality of groups (Gr.) by each key value according to a key and managed separately from other random access data.

Furthermore in an application program of big data processing where a large array is secured in a source code of the program to be executed in the host 30, the memory processing may be executed assuming that the same array is of the same type of data and an application range of the processing includes searching a large-scale database and data extraction. Since big data can be read and written at a high speed even in the above processing, big data processing can be faster.

Specific descriptions have been given with reference to the accompanying drawings; however, preferable embodiments are not limited to the above descriptions and may of course include various modifications without departing from the principals thereof.

Incidentally, a part or all of the configurations of computers or the like, processors, processing means, or the like described in the present invention may be implemented by dedicated hardware.

Moreover, various software exemplified in the present examples may be stored in various recording mediums (for example, a non-transitory recording medium) such as electromagnetic, electronic, and optical recording mediums and may be downloaded to a computer via a communication network such as the Internet.

Incidentally, the present invention is not limited to the aforementioned examples but may include various variations. For example, the aforementioned examples are described in detail in order to facilitate understanding of the present invention and thus the present invention is not necessarily limited to include all of the configurations having been described.

1. An information processing device, comprising:
a host to perform arithmetic processing; and
a memory subsystem connected to the host,
wherein the host notifies a write request comprising data and a type of the data to the memory subsystem, and
the memory subsystem comprises:
a first memory;
a second memory having a size of a data erase unit, for erasing data, larger than a size of a write unit of the data and a data capacity larger than that of the first memory; and
a memory subsystem control module to write random access data and data other than the random access data in different erase units of the second memory based on the type of the data, to manage the random access data by the write unit of the second memory, and to manage the data other than the random access data by the erase unit of the second memory.

2. The information processing device according to claim 1,
wherein the memory subsystem control module dynamically changes a data size of an area of the second memory to write the random access data according to the type of the data included in a write command issued from the host to the memory subsystem.

3. The information processing device according to claim 1,
wherein the type of the data comprises at least one of information to identify whether the data to write is the random access data, information to identify a group number which is a data processing unit of the host, and information to identify the data to write as connection data of a graph, an analysis result of the graph, or vertex information of the graph.

4. The information processing device according to claim 1,
wherein the first memory has a transfer speed of data faster than that of the second memory, and
the second memory is a nonvolatile memory.

5. An information processing device, comprising:
a host to perform arithmetic processing; and
a memory subsystem connected to the host,
wherein the host notifies a write request comprising data and a type of the data to the memory subsystem, and
the memory subsystem comprises:
a first memory;
a second memory having a size of a data erase unit, for erasing data, larger than a size of a write unit of the data and a data capacity larger than that of the first memory; and
a memory subsystem control module to compress the data and to write compressed data of different types of data in different physical areas of the first memory based on the type of the data.

6. The information processing device according to claim 5,
wherein the memory subsystem writes, in different erase units of the second memory, the compressed data of different types of data stored in different areas of the first memory.

7. The information processing device according to claim 5,
wherein the memory subsystem stores, in the first memory, management information corresponding to the compressed data.

8. The information processing device according to claim 7,
wherein the management information comprises a logical address corresponding to the compressed data.

9. The information processing device according to claim 5,
wherein the memory subsystem manages the compressed data by a unit a data size of which is smaller than that of the write unit of the second memory.

10. An information processing device, comprising:
a host to perform arithmetic processing; and
a memory subsystem connected to the host,
wherein the host notifies a write request comprising data and a type of the data to the memory subsystem, and
the memory subsystem comprises:
a first memory;
a second memory having a size of a data erase unit, for erasing data, larger than a size of a write unit of the data and a data capacity larger than that of the first memory; and
a memory subsystem control module to change a method of selecting a physical area of the second memory as a writing destination of the data based on the type of the data.

11. The information processing device according to claim 10,
wherein the memory subsystem manages an identifier of a write unit where writing of data has been performed on the second memory most recently.

12. The information processing device according to claim 10,
wherein the second memory comprises memories of two or more types having different upper limits of erase cycles, and
the memory subsystem determines, of the second memories having different upper limits of the erase cycles, the second memory of which upper limit of the erase cycle to write the data based on the type of the data.
